(19) United States
(12) Patent Application Publication
(10) Pub. No.: US 2003/0063781 A1
(43) Pub. Date: Apr. 3, 2003

(54) Face recognition from a temporal sequence of face images

(75) Inventors: Vasanth Philomin, Briaroliff Manor, NY (US); Miroslav Trajkovic, Ossining, NY (US); Srinivas Gutta, Buchanan, NY (US)

Correspondence Address: Corporate Patent Counsel, U.S. Philips Corporation, 580 White Plains Road, Tarrytown, NY, 10591, US

(73) Assignee: koninklijke Philips Electronics N.V.

(21) Appl. No.: 09/966,409

(22) Filed: Sep. 28, 2001

(51) Int. Cl. G06K 9/00

(52) U.S. Cl. 382/118

(57) ABSTRACT

A system and method for classifying facial images from a temporal sequence of images, comprises the steps of: training a classifier device for recognizing facial images, the classifier device being trained with input data associated with a full facial image; obtaining a plurality of probe images of the temporal sequence of images; aligning each of the probe images with respect to each other; combining the images to form a higher resolution image; and, classifying said higher resolution image according to a classification method performed by the trained classifier device.

### BACKGROUND OF THE INVENTION

1. Field of the Invention

The present invention relates to face recognition systems and particularly, to a system and method for performing face recognition using a temporal sequence of face images in order to improve the robustness of recognition.

2. Discussion of the Prior Art

Face recognition is an important research area in human computer interaction and many algorithms and classifier devices for recognizing faces have been proposed. Typically, face recognition systems store a full facial template obtained from multiple instances of a subject's face during training of the classifier device, and compare a single probe (test) image against the stored templates to recognize the individual.

FIG. 1 illustrates a traditional classifier device 10 comprising, for example, a Radial Basis Function (RBF) network having a layer 12 of input nodes, a hidden layer 14 comprising radial basis functions and an output layer 18 for providing a classification. A description of an RBF classifier device is available from commonly-owned, co-pending U.S. patent application Ser. No. 09/794,443 entitled CLASSIFICATION OF OBJECTS THROUGH MODEL ENSEMBLES filed Feb. 27, 2001, the whole contents and disclosure of which is incorporated by reference as if fully set forth herein.

As shown in FIG. 1, a single probe (test) image 25 including input vectors 26 comprising data representing pixel values of the image, is compared against the stored templates for face recognition. It is well known that face recognition from a single face image is a difficult problem, especially when that face image is not completely frontal. Typically, a video clip of an individual is available for such a face recognition task. By using just one face image or each one of these face images individually by themselves, a lot of temporal information is wasted.

It would be highly desirable to provide a face recognition system and method that utilizes several successive face images of an individual from a video sequence to improve the robustness of recognition.

### SUMMARY OF THE INVENTION

Accordingly, it is an object of the present invention to provide a face recognition system and method that utilizes several successive face images of an individual from a video sequence to improve the robustness of recognition.

It is a further object of the present invention to provide a face recognition system and method that enables multiple probe (test) images to be combined in a manner to provide a single higher resolution image that may be used by a face recognition system to yield better recognition rates.

In accordance with the principles of the invention, there is provided a system and method for classifying facial images from a temporal sequence of images, the method comprising the steps of:

a) training a classifier device for recognizing facial images, said classifier device being trained with input data associated with a full facial image;

b) obtaining a plurality of probe images of said temporal sequence of images;

c) aligning each of said probe images with respect to each other;

d) combining said images to form a higher resolution image; and,

e) classifying said higher resolution image according to a classification method performed by said trained classifier device.

Advantageously, the system and method of the invention enables the combination of several partial views of a face image to create a better single view of the face for recognition. As the success rate of the face recognition is related to the resolution of the image, the higher the resolution, the higher the success rate. Therefore, the classifier is trained with the high-resolution images. If a single low-resolution image is received, the recognizer will still work, but if a temporal sequence is received, a high-resolution image is created and the classifier will work even better.

### BRIEF DESCRIPTION OF THE DRAWINGS

Details of the invention disclosed herein shall be described below, with the aid of the figures listed below, in which:

FIG. 1 is a diagram depicting an RBF classifier device 10 applied for face recognition and classification according to prior art techniques;

FIG. 2 is a diagram depicting an RBF classifier device 10′ implemented for face recognition in accordance with the principles of the invention; and,

FIG. 3 is a diagram depicting how a high resolution image is created after warping.

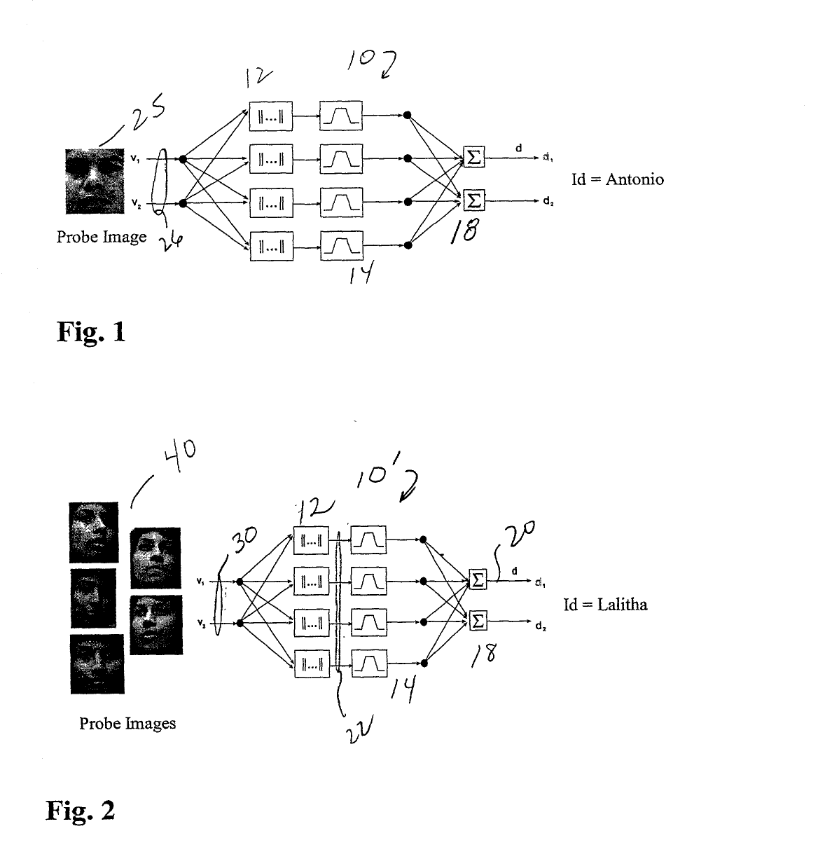

### DETAILED DESCRIPTION OF THE PREFERRED EMBODIMENTS

FIG. 2 illustrates a proposed classifier 10′ of the invention that enables multiple probe images 40 of the same individual from a sequence of images are used simultaneously. It is understood that for purposes of description an RBF network 10′ may be used, however, any classification method/device may be implemented.

The advantage of using several probe images simultaneously is that it enables the creation of a single higher quality and/or higher resolution probe image that may then be used by the face recognition system to yield better recognition rates. First, in accordance with the principles of the invention described in commonly-owned, co-pending U.S. patent application Ser. No. ______ [Attorney Docket 702053, Atty D# 14901] entitled FACE RECOGNITION THROUGH WARPING, the contents and disclosure of which are incorporated by reference as if fully set forth herein, the probe images are warped slightly with respect to each other so that they are aligned. That is, the orientation of each probe image can be calculated and warped on to a frontal view of the face.

Particularly, as described in commonly-owned, co-pending U.S. patent application Ser. No. ______ [Attorney Docket 702053, Atty D# 14901], the algorithm for performing face recognition from an arbitrary face pose (up to 90 degrees) relies on some techniques that may be known and already available to skilled artisans: 1) Face detection techniques; 2) Face pose estimation techniques; 3) Generic three-dimensional head modeling where generic head models are often used in computer graphics comprising of a set of control points (in three dimensions (3-D)) that are used to produce a generic head. By varying these points, a shape that will correspond to any given head may be produced, with a pre-set precision, i.e., the higher the number of points the better precision; 4) View morphing techniques, whereby given an image and a 3-D structure of the scene, an exact image may be created that will correspond to an image obtained from the same camera in the arbitrary position of the scene. Some view morphing techniques do not require an exact, but only an approximate 3-D structure of the scene and still provide very good results such as described in the reference to S. J. Gortler, R. Grzeszczuk, R. Szelisky and M. F. Cohen entitled “The lumigraph” SIGGRAPH 96, pages 43-54; and 5) Face recognition from partial faces, as described in commonly-owned, co-pending U.S. patent application Ser. Nos. ______ [Attorney Docket 702052, D#14900 and Attorney Docket 702054, D#14902], the contents and disclosure of which is incorporated by reference as if fully set forth herein.

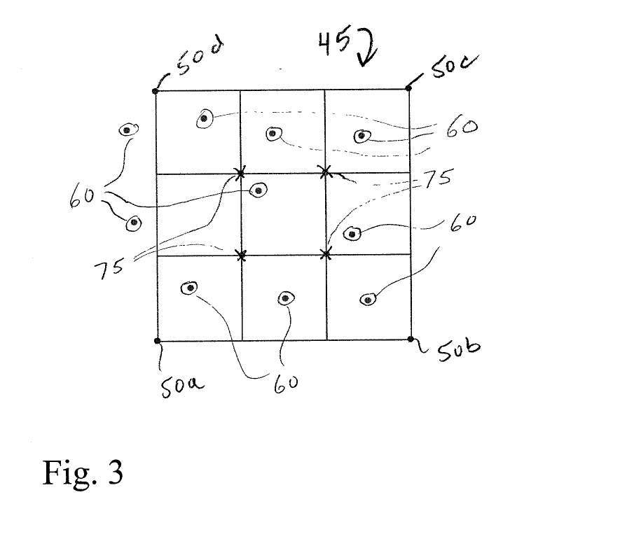

Once this algorithm is performed, there is obtained as many pixels as the number of probe images at any given pixel location. These images may then be combined into a higher resolution image, such as shown and described with respect to FIG. 3, that may help increase the recognition scores. Another advantage is that a combination of several of these partial views, i.e., views in the probe image, provides a better view of the face for recognition. Preferably, as shown in FIG. 2, one or more faces comprising the plurality of images 40 is oriented differently in each probe image and is not fully visible on each probe image. If just one of the probe images (for instance, one without a frontal view) is used instead, current face recognition systems may not be able to recognize the individual from this single non-frontal face image since they require a face image that may be, at most, ±15° from the fully frontal position.

More specifically, according to the invention, the multiple probe images are combined together into a single higher resolution image. First, these images are aligned with each other based on correspondences from the warping methods applied in accordance with the teachings of commonly-owned, co-pending U.S. patent application Ser. No. ______ [Attorney Docket 702053, Atty D# 14901]and, once this is performed, at most pixel points (i, j), there are as many pixels available as the number of probe images. It is understood that after alignment, there may be some locations where not all the probe images contribute to after warping them. The resolution is simply increased as there are many pixel values available at each location. As the success rate of the face recognition is related to the resolution of the image, the higher the resolution, the higher the success rate. Therefore, the classifier device used for recognition is trained with the high-resolution images. If a single low-resolution image is received, the recognizer will still work, but if a temporal sequence is received, a high-resolution image is created and the classifier will work even better.

FIG. 3 is a diagram depicting conceptually how a high-resolution image is created after warping. As shown in FIG. 3, points 50a-50d points denote pixels of an image 45 at locations corresponding to a frontal view of a face. Points 60 correspond to the position of points from other images from the given temporal sequence 40 after warping them into image 45. Note that the coordinates of these points are floating point numbers. Points 75 correspond to the inserted pixels of a resulting high-resolution image. The image value at these locations is computed as an interpolation of the points 60. One method for doing this is to fit a surface to points 50a-50d and points 60 (any polynomial would do) and then estimate value of the polynomial at the location of interpolated points 75.

Preferably, the successive face images, i.e., probe images, are extracted from test sequence automatically from the output of some face detection/tracking algorithm well known in the art, such as the system described in the reference to A. J. Colmenarez and T. S. Huang entitled “Face detection with information-based maximum discrimination,” Proc. IEEE Computer Vision and Pattern Recognition, Puerto Rico, USA, pp. 782-787, 1997, the whole contents and disclosure of which is incorporated by reference as if fully set forth herein.

For purposes of description, a Radial Basis Function (“RBF”) classifier such as shown in FIG. 2, is implemented, but it is understood that any classification method/device may be implemented. A description of an RBF classifier device is available from commonly-owned, co-pending U.S. Pat. application Ser. No. 09/794,443 entitled CLASSIFICATION OF OBJECTS THROUGH MODEL ENSEMBLES filed Feb. 27, 2001, the whole contents and disclosure of which is incorporated by reference as if fully set forth herein.

The construction of an RBF network as disclosed in commonly-owned, co-pending U.S. patent application Ser. No. 09/794,443, is now described with reference to FIG. 2. As shown in FIG. 2, the RBF network classifier 10′ is structured in accordance with a traditional three-layer back-propagation network including a first input layer 12 made up of source nodes (e.g., k sensory units); a second or hidden layer 14 comprising i nodes whose function is to cluster the data and reduce its dimensionality; and, a third or output layer 18 comprising j nodes whose function is to supply the responses 20 of the network 10′ to the activation patterns applied to the input layer 12. The transformation from the input space to the hidden-unit space is non-linear, whereas the transformation from the hidden-unit space to the output space is linear. In particular, as discussed in the reference to C. M. Bishop, “Neural Networks for Pattern Recognition,” Clarendon Press, Oxford, 1997, Ch. 5, the contents and disclosure of which is incorporated herein by reference, an RBF classifier network 10′ may be viewed in two ways: 1) to interpret the RBF classifier as a set of kernel functions that expand input vectors into a high-dimensional space in order to take advantage of the mathematical fact that a classification problem cast into a high-dimensional space is more likely to be linearly separable than one in a low-dimensional space; and, 2) to interpret the RBF classifier as a function-mapping interpolation method that tries to construct hypersurfaces, one for each class, by taking a linear combination of the Basis Functions (BF). These hypersurfaces may be viewed as discriminant functions, where the surface has a high value for the class it represents and a low value for all others. An unknown input vector is classified as belonging to the class associated with the hypersurface with the largest output at that point. In this case, the BFs do not serve as a basis for a high-dimensional space, but as components in a finite expansion of the desired hypersurface where the component coefficients, (the weights) have to be trained.

In further view of FIG. 2, the RBF classifier 10′, connections 22 between the input layer 12 and hidden layer 14 have unit weights and, as a result, do not have to be trained. Nodes in the hidden layer 14, i.e., called Basis Function (BF) nodes, have a Gaussian pulse nonlinearity specified by a particular mean vector μᵢ (i.e., center parameter) and variance vector σᵢ² (i.e., width parameter), where i=1, . . . , F and F is the number of BF nodes. Note that σᵢ² represents the diagonal entries of the covariance matrix of Gaussian pulse (i). Given a D-dimensional input vector X, each BF node (i) outputs a scalar value yᵢ reflecting the activation of the BF caused by that input as represented by equation 1) as follows:

$${y}_{i} = {φ}_{i} ( ‖ X - {μ}_{i} ‖ ) = exp [ - {\sum }_{k = 1}^{D} \frac{{( {x}_{k} - {μ}_{i k} )}^{2}}{2 h {σ}_{i k}^{2}} ] , \qquad ( 1 )$$

Where h is a proportionality constant for the variance, Xₖ is the k^{th} component of the input vector X=[X₁, X₂, . . . , X_{D}], and μᵢₖ² and σᵢₖ² are the k^{th} components of the mean and variance vectors, respectively, of basis node (i). Inputs that are close to the center of the Gaussian BF result in higher activations, while those that are far away result in lower activations. Since each output node 18 of the RBF network forms a linear combination of the BF node activations, the portion of the network connecting the second (hidden) and output layers is linear, as represented by equation 2) as follows:

$${z}_{j} = {\sum }_{i} {w}_{ij} {y}_{i} + {w}_{oj} \qquad ( 2 )$$

where Zⱼ is the output of the j^{th} output node, yᵢ is the activation of the i^{th} BF node, wᵢⱼ is the weight 24 connecting the i^{th} BF node to the j^{th} output node, and wₒⱼ is the bias or threshold of the j^{th} output node. This bias comes from the weights associated with a BF node that has a constant unit output regardless of the input.

An unknown vector X is classified as belonging to the class associated with the output node j with the largest output Zⱼ. The weights wᵢⱼ in the linear network are not solved using iterative minimization methods such as gradient descent. They are determined quickly and exactly using a matrix pseudo inverse technique such as described in above-mentioned reference to C. M. Bishop, “Neural Networks for Pattern Recognition,” Clarendon Press, Oxford, 1997.

A detailed algorithmic description of the preferable RBF classifier that may be implemented in the present invention is provided herein in Tables 1 and 2. As shown in Table 1, initially, the size of the RBF network 10′ is determined by selecting F, the number of BFs nodes. The appropriate value of F is problem-specific and usually depends on the dimensionality of the problem and the complexity of the decision regions to be formed. In general, F can be determined empirically by trying a variety of Fs, or it can set to some constant number, usually larger than the input dimension of the problem. After F is set, the mean μ_{I} and variance σ_{I}² vectors of the BFs may be determined using a variety of methods. They can be trained along with the output weights using a back-propagation gradient descent technique, but this usually requires a long training time and may lead to suboptimal local minima. Alternatively, the means and variances may be determined before training the output weights. Training of the networks would then involve only determining the weights.

The BF means (centers) and variances (widths) are normally chosen so as to cover the space of interest. Different techniques may be used as known in the art: for example, one technique implements a grid of equally spaced BFs that sample the input space; another technique implements a clustering algorithm such as k-means to determine the set of BF centers; other techniques implement chosen random vectors from the training set as BF centers, making sure that each class is represented.

Once the BF centers or means are determined, the BF variances or widths σ_{I}² may be set. They can be fixed to some global value or set to reflect the density of the data vectors in the vicinity of the BF center. In addition, a global proportionality factor H for the variances is included to allow for resealing of the BF widths. By searching the space of H for values that result in good performance, its proper value is determined.

After the BF parameters are set, the next step is to train the output weights wᵢⱼ in the linear network. Individual training patterns X(p) and their class labels C(p) are presented to the classifier, and the resulting BF node outputs y_{I}(p), are computed. These and desired outputs dⱼ(p) are then used to determine the F×F correlation matrix “R” and the F×M output matrix “B”. Note that each training pattern produces one R and B matrices. The final R and B matrices are the result of the sum of N individual R and B matrices, where N is the total number of training patterns. Once all N patterns have been presented to the classifier, the output weights wᵢⱼ are determined. The final correlation matrix R is inverted and is used to determine each wᵢⱼ.

TABLE 1
1. Initialize

| | |
|---|---|
| (a) | Fix the network structure by selecting F, the number of |
| | basis functions, where each basis function I has the |
| | output where k is the component index. |
| | ${y}_{i} = {φ}_{i} ( ‖ X - {μ}_{i} ‖ ) = exp [ - {\sum }_{k = 1}^{D} \frac{{( {x}_{k} - {μ}_{ik} )}^{2}}{2 h {σ}_{ik}^{2}} ] ,$ |
| (b) | Determine the basis function means μ_{I}, where I = 1, . . . , |
| | F, using K-means clustering algorithm. |
| (c) | Determine the basis function variances σ_{I}², where I = 1, |
| | . . . , F. |
| (d) | Determine H, a global proportionality factor for the |
| | basis function variances by empirical search |

2. Present Training

| | |
|---|---|
| (a) | Input training patterns X(p) and their class labels C(p) |
| | to the classifier, where the pattern index is p = 1, . . . , N. |
| (b) | Compute the output of the basis function nodes y_{I}(p), |
| | where I = 1, . . . , F, resulting from pattern X(p). |
| | ${R}_{il} = {\sum }_{p} {y}_{i} ( p ) {y}_{l} ( p )$ |
| (c) | Compute the F × F correlation matrix R of the basis |
| | function outputs: |
| (d) | Compute the F × M output matrix B, where dⱼ is the |
| | desired output and M is the number of output classes: |
| | ${B}_{lj} = {\sum }_{p} {y}_{l} ( p ) {d}_{j} ( p ) , where {d}_{j} ( p ) = \{ \begin{matrix}1 & if C ( p ) = j \\ 0 & otherwise\end{matrix} ,$ |
| | and j = 1, . . . , M. |

3. Determine Weights

| | |
|---|---|
| (a) | Invert the F × F correlation matrix R to get R⁻¹. |
| (b) | Solve for the weights in the network using the following |
| | equation: |
| | ${w}_{ij}^{*} = {\sum }_{l} {( {R}^{- 1} )}_{il} {B}_{lj}$ |

As shown in Table 2, classification is performed by presenting an unknown input vector Xₜₑₛₜ to the trained classifier and computing the resulting BF node outputs yᵢ. These values are then used, along with the weights wᵢⱼ, to compute the output values zⱼ. The input vector Xₜₑₛₜ is then classified as belonging to the class associated with the output node j with the largest Zⱼ output.

TABLE 2
1. Present input pattern Xₜₑₛₜ comprising half-face image
to the classifier
2. Classify Xtest

| | |
|---|---|
| (a) | Compute the basis function outputs, for all F |
| | basis functions |
| (b) | Compute output node activations: |
| | ${z}_{j} = {\sum }_{i} {w}_{ij} {y}_{i} + {w}_{oj}$ |
| (c) | Select the output zⱼ with the largest value and |
| | classify Xₜₑₛₜ as the class j. |

In the method of the present invention, the RBF input comprises a temporal sequence of n size normalized facial gray-scale images fed to the network RBF network 10′ as one-dimensional, i.e., 1-D vectors 30. The hidden (unsupervised) layer 14, implements an “enhanced” k-means clustering procedure, such as described in S. Gutta, J. Huang, P. Jonathon and H. Wechsler entitled “Mixture of Experts for Classification of Gender, Ethnic Origin, and Pose of Human Faces,” IEEE Transactions on Neural Networks, 11(4):948-960, July 2000, incorporated by reference as if fully set forth herein, where both the number of Gaussian cluster nodes and their variances are dynamically set. The number of clusters may vary, in steps of 5, for instance, from 1/5 of the number of training images to n, the total number of training images. The width σ_{I}² of the Gaussian for each cluster, is set to the maximum (the distance between the center of the cluster and the farthest away member—within class diameter, the distance between the center of the cluster and closest pattern from all other clusters) multiplied by an overlap factor o, here equal to 2. The width is further dynamically refined using different proportionality constants h. The hidden layer 14 yields the equivalent of a functional shape base, where each cluster node encodes some common characteristics across the shape space. The output (supervised) layer maps face encodings (‘expansions’) along such a space to their corresponding ID classes and finds the corresponding expansion (‘weight’) coefficients using pseudo inverse techniques. Note that the number of clusters is frozen for that configuration (number of clusters and specific proportionality constant h) which yields 100% accuracy on ID classification when tested on the same training images.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for classifying facial images from a temporal sequence of images, the method comprising the steps of:
a) training a classifier device for recognizing facial images, said classifier device being trained with input data associated with a full facial image;
b) obtaining a plurality of probe images of said temporal sequence of images;
c) aligning each of said probe images with respect to each other;
d) combining said images to form a higher resolution image; and,
e) classifying said higher resolution image according to a classification method performed by said trained classifier device.

2. The method of claim 1, wherein each face is oriented differently in each probe image.

3. The method of claim 1, wherein the probe images are warped slightly with respect to each other so that they are aligned.

4. The method of claim 3, wherein said step b) includes automatically extracting successive face images from a test sequence from the output of a face detection algorithm.

5. The method of claim 3, wherein said aligning step c) includes the step of orientating each probe image and warping each image on to a frontal view of the face.

6. The method of claim 5, wherein said warping of an image comprises the steps of:
finding a head pose of said detected partial view;
defining a generic head model and rotating said generic head model (GHM) so that it has the same orientation as the given face image;
translating and scaling said GHM so that one or more features of said GHM coincide with the given face image
recreating said image to obtain a frontal view of the face.

7. The method of claim 1, wherein said steps a) and e) include implementing a Radial Basis Function Network.

8. The method of claim 6, wherein the training step a) comprises:
(a) initializing the Radial Basis Function Network, the initializing step comprising the steps of:
fixing the network structure by selecting a number of basis functions F, where each basis function I has the output of a Gaussian non-linearity;
determining the basis function means μ_{I}, where I=1, . . . , F, using a K-means clustering algorithm;
determining the basis function variances σ_{I}²; and
determining a global proportionality factor H, for the basis function variances by empirical search;
(b) presenting the training, the presenting step comprising the steps of:
inputting training patterns X(p) and their class labels C(p) to the classification method, where the pattern index is p=1, . . . , N;
computing the output of the basis function nodes y_{I}(p), F, resulting from pattern X(p);
computing the F×F correlation matrix R of the basis function outputs; and
computing the F×M output matrix B, where dⱼ is the desired output and M is the number of output classes and j=1, . . . , M; and
(c) determining weights, the determining step comprising the steps of:
inverting the F×F correlation matrix R to get R⁻¹; and
solving for the weights in the network.

9. The method of claim 8, wherein the classifying step e) comprises:
presenting an unknown higher resolution image from said temporal sequence to the classification method; and
classifying each higher resolution image by:
computing the basis function outputs, for all F basis functions;
computing output node activations; and
selecting the output Zⱼ with the largest value and classifying said higher resolution image as a class j.

10. The method of claim 1, wherein the classifying step comprises outputting a class label identifying a class to which the unknown higher resolution image object corresponds to and a probability value indicating the probability with which the unknown pattern belongs to the class for each of the two or more features.

11. An apparatus for classifying facial images from a temporal sequence of images, the apparatus comprising:
a) classifier device trained for recognizing facial images from input data associated with a full facial image;
b) mechanism for obtaining a plurality of probe images of said temporal sequence of images;
c) mechanism for aligning each of said probe images with respect to each other and, combining said images to form a higher resolution image, wherein said higher resolution image is classified according to a classification method performed by said trained classifier device.

12. A program storage device readable by machine, tangibly embodying a program of instructions executable by the machine to perform method steps for classifying facial images from a temporal sequence of images, the method comprising the steps of:
a) training a classifier device for recognizing facial images, said classifier device being trained with input data associated with a full facial image;
b) obtaining a plurality of probe images of said temporal sequence of images;
c) aligning each of said probe images with respect to each other;
d) combining said images to form a higher resolution image; and
e) classifying said higher resolution image according to a classification method performed by said trained classifier device.
